(19) United States
(12) Patent Application Publication
(10) Pub. No.: US 2025/0156721 A1
(43) Pub. Date: May 15, 2025

(54) NEURAL NETWORK OPTIMIZATION METHOD

(71) Applicant: MEDIATEK INC., Hsinchu City (TW)

(72) Inventors: Chun-Wei Yang, Hsinchu City (TW); Bo-Yu Kuo, Hsinchu City (TW); Cheng-Sheng Chan, Hsinchu City (TW); Sheng-Je Hung, Hsinchu City (TW)

(73) Assignee: MEDIATEK INC., Hsinchu City (TW)

(21) Appl. No.: 18/940,856

(22) Filed: Nov. 8, 2024

Related U.S. Application Data
(60) Provisional application No. 63/597,687, filed on Nov. 9, 2023.

(51) Int. Cl. G06N 3/092

(52) U.S. Cl. CPC G06N 3/092

(57) ABSTRACT

A neural network optimization method includes: executing a population-based algorithm to tune and evaluate a policy group, in order to generate one or more evaluation results, wherein the policy group comprises one or more policies, and each of the one or more policies is related to a neural network; executing a learning-based algorithm to tune the one or more policies according to the one or more evaluation results, to generate one or more tuned policies; performing an inference operation according to a target neural network and the one or more tuned policies, to generate multiple configuration candidates; and performing a selection operation upon the multiple configuration candidates to generate an optimal configuration, for outputting to a compiler and generating an optimized neural network, wherein the optimized neural network is an optimized version of the target neural network.

### CROSS REFERENCE TO RELATED APPLICATIONS

This application claims the benefit of U.S. Provisional Application No. 63/597, 687, filed on Nov. 9, 2023. The content of the application is incorporated herein by reference.

### BACKGROUND

The present invention is related to neural network, and more particularly, to a neural network optimization method and a non-transitory machine-readable medium for storing a program code that performs the neural network optimization method when executed.

With the development of artificial: intelligence (AI), optimizing neural networks has gradually become an important issue. In order to improve the performance of a neural network, tensor tiling and layer fusion at the graph level can be set to convert the computation graph of the neural network, so that the parallelization during an evaluation operation can be increased and thereby the performance of the neural network can be improved. For an existing method, the above settings for the neural network may be performed manually, which is quite time-consuming and inefficient, and can only focus on a single objective (e.g., a single objective requiring the neural network to have a low latency when running). In addition, the existing method may find an optimal configuration among multiple configurations between the tensor tiling and the layer fusion by grid searching, for inputting to a compiler to generate an optimized neural network. However, since the number of configurations may be quite large, it will be quite difficult to find the optimal configuration through grid searching.

### SUMMARY

It is therefore one of the objectives of the present invention to provide a neural network optimization method that can automatically find corresponding optimal configurations for different neural networks by executing a learning-based algorithm and a population-based algorithm, and a non-transitory machine-readable medium for storing a program code that provides the neural network optimization method when executed, to address the above-mentioned issues.

According to an embodiment of the present invention, a neural network optimization method is provided. The neural network optimization method comprises: executing a population-based algorithm to tune and evaluate a policy group, in order to generate one or more evaluation results, wherein the policy group comprises one or more policies, and each of the one or more policies is related to a neural network; executing a learning-based algorithm to tune the one or more policies according to the one or more evaluation results, in order to generate one or more tuned policies; performing an inference operation according to a target neural network and the one or more tuned policies, in order to generate multiple configuration candidates; and performing a selection operation upon the multiple configuration candidates to generate an optimal configuration, for outputting to a compiler and generating an optimized neural network, wherein the optimized neural network is an optimized version of the target neural network.

According to an embodiment of the present invention, a non-transitory machine-readable medium for storing a program code is provided, wherein when loaded and executed by a processor, the program code instructs the processor to perform a neural network optimization method, and the neural network optimization method comprises: executing a population-based algorithm to tune and evaluate a policy group, in order to generate one or more evaluation results, wherein the policy group comprises one or more policies, and each of the one or more policies is related to a neural network; executing a learning-based algorithm to tune the one or more policies according to the one or more evaluation results, in order to generate one or more tuned policies; performing an inference operation according to a target neural network and the one or more tuned policies, in order to generate multiple configuration candidates; and performing a selection operation upon the multiple configuration candidates to generate an optimal configuration, for outputting to a compiler and generating an optimized neural network, wherein the optimized neural network is an optimized version of the target neural network.

One of the benefits of the present invention is that, by the neural network optimization method of the present invention, both the learning-based algorithm and the population-based algorithm can be executed to tune the policies and generate configurations, for outputting to the compiler, which can improve the performance of the neural network, wherein the trade-off between multiple objectives can be managed by executing the population-based algorithm. In addition, the one or more tuned policies generated in the tuning phase can be reused in the inference phase for other neural networks that are different from the neural network involved in the tuning phase, which greatly shortens the processing time (e.g., the optimization time) of other neural networks. Furthermore, the present invention uses multi-level evaluation (e.g., evaluators of different levels in the tuning phase and the selection phase) to handle tasks with different complexity. In the tuning phase, due to the large number of policies to be evaluated in the policy group, a fast but less accurate evaluator (e.g., the surrogate evaluator) is used. In the selection phase, since the number of configuration candidates is relatively small, a precise evaluator will be used. In this way, the overall processing time (e.g. the optimization time) can be accelerated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a block diagram of a neural network optimization flow according to an embodiment of the present invention.

FIG. 3 is a diagram illustrating implemental details of generating an optimal configuration according to an embodiment of the present invention.

FIG. 4 is a diagram illustrating implemental details of the tuning phase shown in FIG. 3 according to an embodiment of the present invention.

FIG. 5 is a diagram illustrating implemental details of the inference phase shown in FIG. 3 according to an embodiment of the present invention.

FIG. 6 is a diagram illustrating implemental details of the selection phase shown in FIG. 3 according to an embodiment of the present invention.

FIG. 7 is a diagram illustrating implemental details of generating an optimal configuration according to another embodiment of the present invention.

FIG. 8 is a flow chart of a neural network optimization method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

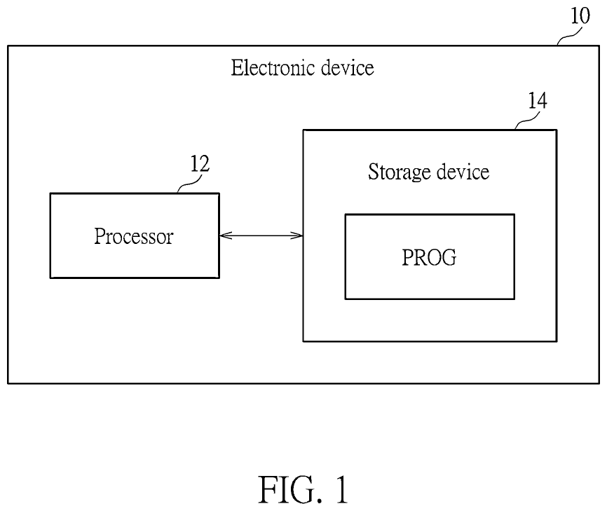

FIG. 1 is a diagram illustrating an electronic device 10 according to an embodiment of the present invention. By way of example, but not limitation, the electronic device 10 may be a portable device such as a smartphone or a tablet. The electronic device 10 may include a processor 12 and a storage device 14. The processor 12 may be a single-core processor or a multi-core processor. The storage device 14 is a non-transitory machine-readable medium, and is arranged to store computer program code PROG. The processor 12 is equipped with software execution capability. The computer program code PROG may include multiple neural network optimization algorithms. When loaded and executed by the processor 12, the computer program code PROG instructs the processor 12 to perform a neural network optimization method as proposed by the present invention. The electronic device 10 may be regarded as a computer system using a computer program product that includes a computer-readable medium containing the computer program code PROG. That is, the neural network optimization method of the present invention may be embodied on the electronic device 10.

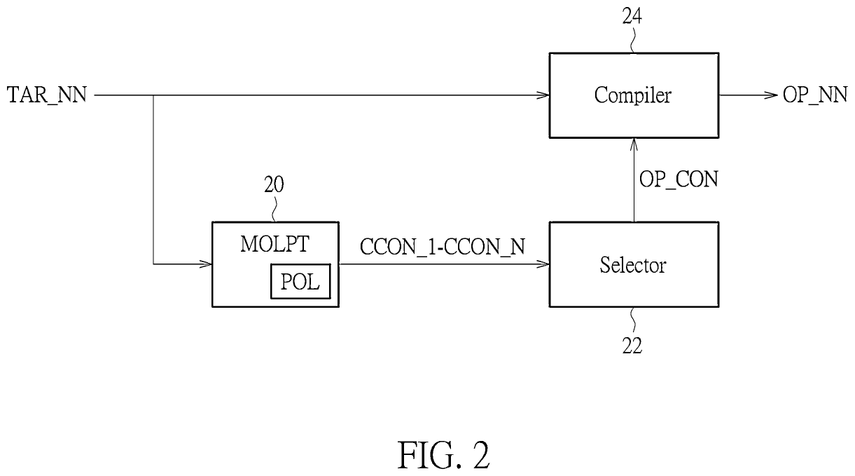

FIG. 2 is a block diagram of a neural network optimization flow according to an embodiment of the present invention. As shown in FIG. 2, the processor 12 may be further arranged to execute software modules, including a multi-objective learnable population-based tuner (MOLPT) 20, a selector 22, and a compiler 24. The MOLPT 20 may be arranged to execute a learning-based algorithm and a population-based algorithm to train one or more policies POL according to a target neural network TAR_NN, wherein each of the policies POL is arranged to generate a configuration regarding some characteristics (e.g., layer fusion and tensor tiling) of the target neural network TAR_NN, for providing to the compiler 24. The MOLPT 20 may generate multiple configuration candidates CCON_1-CCON_N according to the policies POL, wherein N may be an integer greater than 1. The selector 22 may be arranged to perform a selection operation upon the configuration candidates CCON_1-CCON_N to generate an optimal configuration OP_CON. The compiler 24 may be arranged to compile the optimal configuration OP_CON to generate an optimized neural network OP_NN, wherein the optimized neural network OP_NN is an optimized version of the target neural network TAR_NN. Since the focus of the present invention is on generating the configuration candidates CCON_1-CCON_N by executing the learning-based algorithm and the population-based algorithm and deriving the optimal configuration OP_CON from the configuration candidates CCON_1-CCON_N, and the operations of the compiler 24 are well known to those skilled in the art, the details of the compiler 24 will be omitted for brevity.

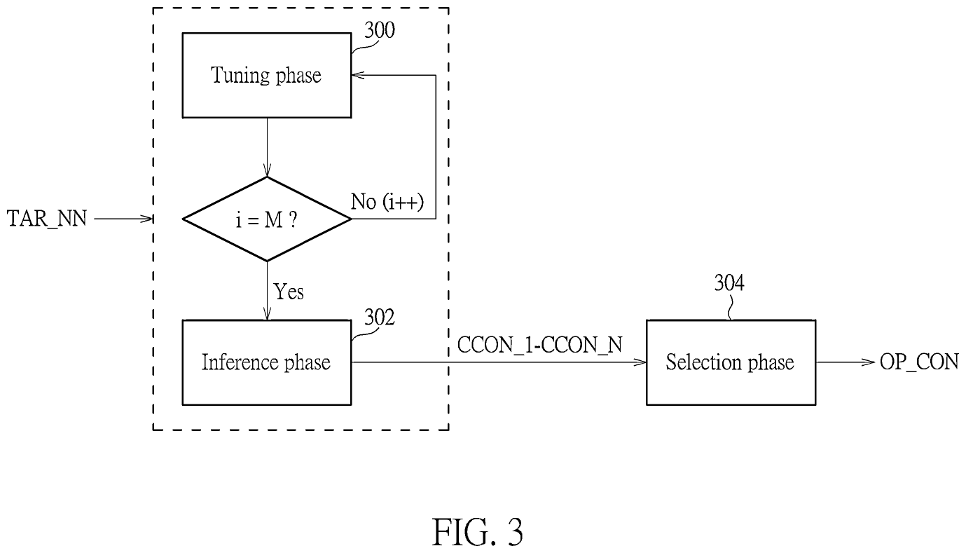

Specifically, please refer to FIG. 3. FIG. 3 is a diagram illustrating implemental details of generating the optimal configuration OP_CON according to an embodiment of the present invention. The operations of the MOLPT 20 shown in FIG. 2 may be divided into a tuning phase 300 and an inference phase 302. The operations of the selector 22 shown in FIG. 2 may be performed in a selection phase 304. In the tuning phase 300, the learning-based algorithm and the population-based algorithm are executed to tune a policy group, including the policies POL, to generate one or more tuned policies TPOL, for providing to the inference phase 302 to generate the configuration candidates CCON_1-CCON_N by performing an inference operation.

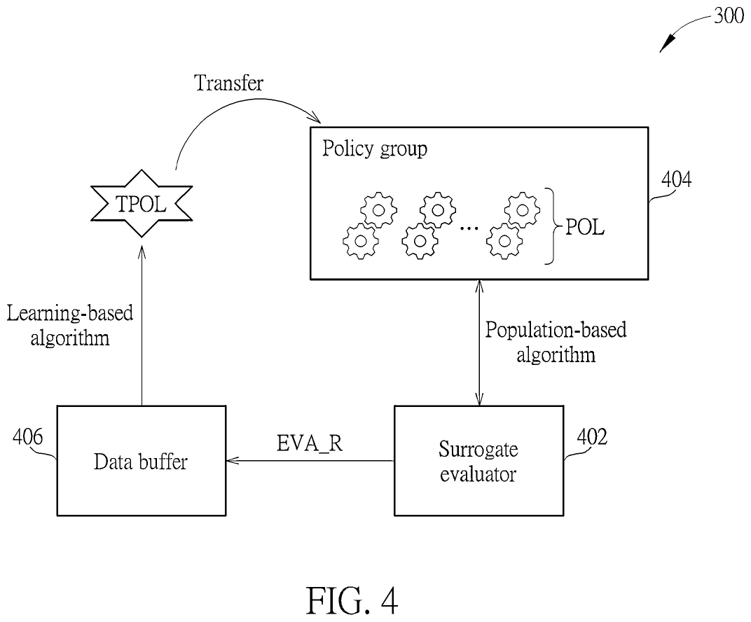

FIG. 4 is a diagram illustrating implemental details of the tuning phase 300 shown in FIG. 3 according to an embodiment of the present invention. As shown in FIG. 4, the processor 12 may be further arranged to execute a surrogate evaluator 402. The surrogate evaluator 402 may be arranged to execute the population-based algorithm to tune and evaluate a policy group 404 (more particularly, each of the policies POL included in the policy group 404) according to at least one objective, in order to generate one or more evaluation results EVA_R for determining whether to remain the each of the policies POL in the policy group 404. For example, the surrogate evaluator 402 may evaluate the each of the policies POL according to latency and power consumption of the each of the policies POL. When multiple objectives require low latency and low power consumption, the one or more evaluation results EVA_R may indicate policies conforming to the objectives. By executing the population-based algorithm, policies with high latency and/or high power consumption may be removed from the policy group 404 according to the one or more evaluation results EVA_R, and only policies with low latency and low power consumption are remained in the policy group 404 for subsequent operations. As a result, the surrogate evaluator 402 may effectively manage trade-off between the multiple objectives by performing the population-based algorithm. In addition, by adopting the surrogate evaluator 402 (which is fast but less accurate) to avoid the time-consuming evaluation operation, the tuning process can be accelerated.

Afterwards, the one or more evaluation results EVA_R may be stored in a data buffer 406. The learning-based algorithm may be executed according to the one or more evaluation results EVA_R acting as input data, to tune (e.g., update or adjust) the policies POL included in the policy group 404, to generate the tuned policies TPOL, wherein for each iteration entering the tuning phase 300, the tuned policies TPOL may be transferred in the policy group 404 to update the policies POL included in the policy group 404 (e.g., the policies POL may be replaced by the tuned policies TPOL).

It should be noted that, in order to prevent the configuration generated according to the each of the policies POL from violating a constraint of the compiler 24, the processor 12 may be further arranged to execute a constraint solver (not shown in FIG. 4). For example, the constraint solver may be located between the surrogate evaluator 402 and the policy group 404, and may be arranged to determine whether the configuration of the each of policies POL meets the constraint of the compiler 24. In response to the configuration of the each of policies POL not meeting the constraint of the compiler 24, the constraint solver may revise the configuration according to the constraint of the compiler 24, so that the configuration can be compiled by the compiler 24. This is for illustration only, and the present invention is not limited thereto. In some embodiments, the constraint solver may be in the inference phase 302.

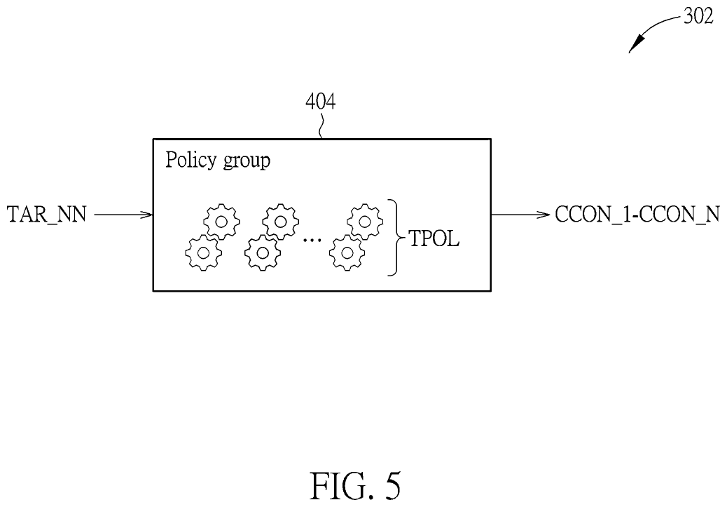

FIG. 5 is a diagram illustrating implemental details of the inference phase 302 shown in FIG. 3 according to an embodiment of the present invention. As shown in FIG. 5, in the inference phase 302, an inference operation may be performed according to the target neural network TAR_NN and the tuned policies TPOL included in the policy group 404, to generate the configuration candidates CCON_1-CCON_N. In some embodiments, the tuned policies TPOL generated in the tuning phase 300 is reusable in the inference phase 302. That is, in the inference phase 302, the inference operation may be performed according to the same tuned policies TPOL and another neural network that is different from the target neural network TAR_NN involved in the tuning phase 300, which greatly reduces the processing time (or the optimization time) of the another neural network.

In addition, in order to prevent the configuration candidates CCON_1-CCON_N from violating the constraint of the compiler 24, the processor 12 may be further arranged to execute a constraint solver (not shown in FIG. 5). The constraint solver may be arranged to determine whether each of the configuration candidates CCON_1-CCON_N meets the constraint of the compiler. In response to the each of the configuration candidates CCON_1-CCON_N (e.g. the configuration candidate CCON_1) not meeting the constraint of the compiler 24, the constraint solver may revise the configuration candidate CCON_1 according to the constraint of the compiler 24, so that the configuration candidate CCON_1 can be compiled by the compiler 24.

Please refer back to FIG. 3. In FIG. 3, an initial value of an index value i may be set as 0 before entering the tuning phase 300 for the first time, and the index value i may be increased with an increment of 1 (labeled “i++” for brevity) after entering the tuning phase 300. It is determined whether the index value i reaches a predetermined value M (e.g., the predetermined value M is a positive integer). If Yes (i.e., the index value i reaches the predetermined value M), the inference phase 302 is entered; if No (i.e., the index value i does not reaches the predetermined value M), the tuning phase 300 is entered again for further tuning the policy group 404. That is, in response to the index value i not reaching the predetermined value M, the population-based algorithm and the learning-based algorithm are kept executed to tune (e.g. update or adjust) the policies POL included in the policy group 404. In response to the index value i reaching the predetermined value M, the inference operation is started to be performed according to the target neural network TAR_NN and the tuned policies TPOL transferred in the policy group POL, to generate the configuration candidates CCON_1-CCON_N. For example, under a situation that the index value i is equal to 10 and reaches the predetermined value M (i.e., i=M=10), it means that the policy group 404 is updated 10 times via executing the population-based algorithm. For each updating operation, a new evaluation result may be stored in the data buffer 406 for executing the learning-based algorithm. That is, in this situation, the number of evaluation results EVA_R stored in the data buffer 406 is 10.

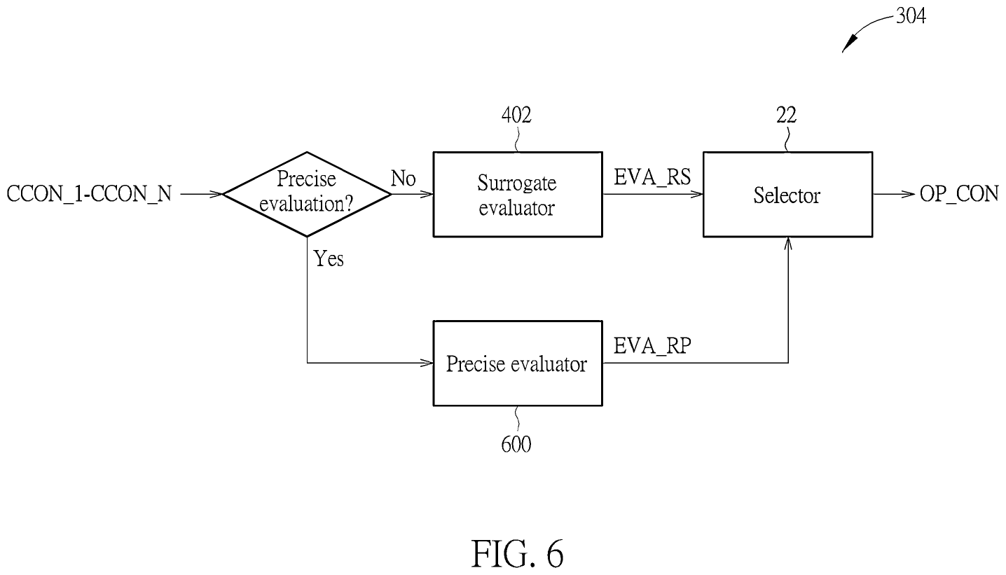

FIG. 6 is a diagram illustrating implemental details of the selection phase 304 shown in FIG. 3 according to an embodiment of the present invention. In the selection phase 304, it is determined whether to perform a precise evaluation operation (i.e., to evaluate the configuration candidates CCON_1-CCON_N in order to generate an evaluation result EVA_RP). The processor 12 may be further arranged to execute a precise evaluator 600. The precise evaluator 600 may perform an evaluation operation upon the configuration candidates CCON_1-CCON_N in order to generate the evaluation result EVA_RP. For example, the precise evaluator 600 may evaluate the each of the configuration candidates CCON_1-CCON_N according to latency and power consumption of the each of the configuration candidates CCON_1-CCON_N in order to generate the evaluation result EVA_RP. When multiple objectives require low latency and low power consumption, the evaluation result EVA_RP may indicate configuration candidates conforming to the objectives, and the selector 22 may remove configuration candidates with high latency and/or high power consumption from the configuration candidates CCON_1-CCON_N according to the evaluation result EVA_RP, and only remain configuration candidates with low latency and low power consumption in the configuration candidates CCON_1-CCON_N for subsequent operations.

It should be noted that the present invention may use evaluators of different levels in the tuning phase 300 and the selection phase 304 to handle tasks with different complexity. In the tuning phase 300, due to the large number of policies POL to be evaluated in the policy group 404, a fast but less accurate evaluator (e.g., the surrogate evaluator 402) is used. In the selection phase 304, since the number of configuration candidates CCON_1-CCON_N is relatively small, the precise evaluator 600 that is more precise than the surrogate evaluator 402 may be optionally used. In this way, the overall optimization process can be accelerated.

In response to determining to evaluate the configuration candidates CCON_1-CCON_N by the precise evaluator 600 in order to generate the evaluation result EVA_RP (labeled as “Yes” in FIG. 6 for brevity), the selector 22 may perform the selection operation upon the configuration candidates CCON_1-CCON_N according to the evaluation result EVA_RP in order to generate the optimal configuration OP_CON. In response to determining to skip precise evaluation of the configuration candidates CCON_1-CCON_N (labeled as “No” in FIG. 6 for brevity), the configuration candidates CCON_1-CCON_N may be evaluated by the surrogate evaluator 402 in order to generate an evaluation result EVA_RS, and the selector 22 may perform the selection operation upon the configuration candidates CCON_1-CCON_N according to the evaluation result EVA_RS of the surrogate evaluator 402 in order to generate the optimal configuration OP_CON, wherein the evaluation result EVA_RP of the precise evaluator 600 may be a precise version of the evaluation result EVA_RS of the surrogate evaluator 402.

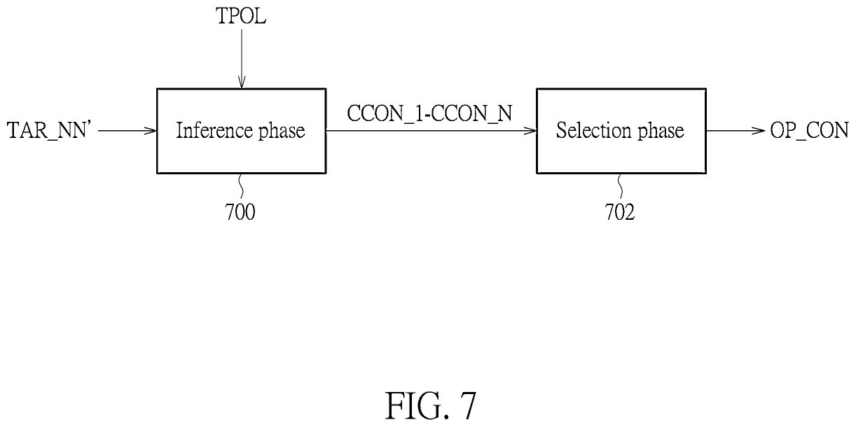

FIG. 7 is a diagram illustrating implemental details of generating the optimal configuration OP_CON according to another embodiment of the present invention. The difference between embodiments shown in FIG. 3 and FIG. 7 is that, for an inference phase 700 in FIG. 7, a target neural network TAR_NN′ is a neural network different from the neural network involved in the tuning phase (e.g., the target neural network TAR_NN shown in FIG. 3), and the inference operation may be performed according to the target neural network TAR_NN′ and previous tuned policies TPOL. That is, the tuned policies TPOL for a neural network can be reused to reduce the processing time (e.g. the optimization time) of other neural networks. Since operations of generating the optimal configuration OP_CON shown in FIG. 7 (e.g., the inference phase 700 and a selection phase 702) are similar to that shown in FIG. 3 (e.g., the inference phase 302 and the selection phase 304), similar descriptions are not repeated in detail here for brevity.

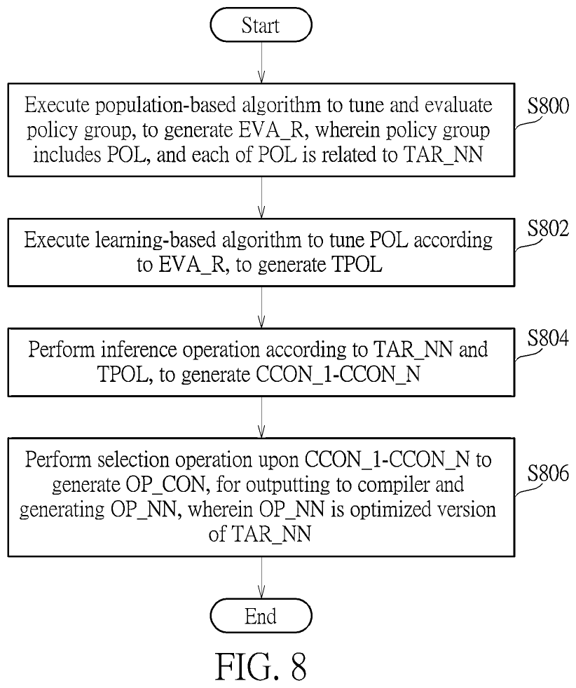

FIG. 8 is a flow chart of a neural network optimization method according to an embodiment of the present invention. Provided that the result is substantially the same, the steps are not required to be executed in the exact order shown in FIG. 8. For example, the neural network optimization method shown in FIG. 8 may be employed by the electronic device 10 shown in FIG. 1.

In Step S800, a population-based algorithm is executed to tune and evaluate the policy group 404, in order to generate the one or more evaluation results EVA_R, wherein the policy group 404 includes the policies POL, and each of the policies POL is related to the target neural network TAR_NN.

In Step S802, a learning-based algorithm is executed to tune the policies POL according to the one or more evaluation results EVA_R, to generate the tuned policies TPOL.

In Step S804, an inference operation is performed according to the target neural network TAR_NN and the tuned policies TPOL, to generate the configuration candidates CCON_1-CCON_N.

In Step S806, a selection operation is performed upon the configuration candidates CCON_1-CCON_N to generate the optimal configuration OP_CON, for outputting to the compiler 24 and generating the optimized neural network OP_NN, wherein the optimized neural network OP_NN is an optimized version of the target neural network TAR_NN.

Since a person skilled in the pertinent art can readily understand details of the steps after reading above paragraphs, further description is omitted here for brevity.

In summary, by the neural network optimization method of the present invention, both the learning-based algorithm and the population-based algorithm can be executed to tune the policies and generate configurations, for outputting to the compiler, which can improve the performance of the neural network, wherein the trade-off between multiple objectives can be managed by executing the population-based algorithm. In addition, the one or more tuned policies generated in the tuning phase can be reused in the inference phase for other neural networks that are different from the neural network involved in the tuning phase, which greatly shortens the processing time (e.g., the optimization time) of other neural networks. Furthermore, the present invention uses multi-level evaluation (e.g., evaluators of different levels in the tuning phase and the selection phase) to handle tasks with different complexity. In the tuning phase, due to the large number of policies to be evaluated in the policy group, a fast but less accurate evaluator (e.g., the surrogate evaluator) is used. In the selection phase, since the number of configuration candidates is relatively small, a precise evaluator will be used. In this way, the overall processing time (e.g. the optimization time) can be accelerated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A neural network optimization method, comprising:
executing a population-based algorithm to tune and evaluate a policy group, in order to generate one or more evaluation results, wherein the policy group comprises one or more policies, and each of the one or more policies is related to a neural network;
executing a learning-based algorithm to tune the one or more policies according to the one or more evaluation results, in order to generate one or more tuned policies;
performing an inference operation according to a target neural network and the one or more tuned policies, in order to generate multiple configuration candidates; and
performing a selection operation upon the multiple configuration candidates in order to generate an optimal configuration, for outputting to a compiler and generating an optimized neural network, wherein the optimized neural network is an optimized version of the target neural network.

2. The neural network optimization method of claim 1, wherein the step of executing the population-based algorithm to tune and evaluate the policy group, in order to generate the one or more evaluation results comprises:
tuning and evaluating the each of the one or more policies according to at least one objective of the neural network, in order to determine whether to remain the each of the one or more policies in the policy group.

3. The neural network optimization method of claim 1, wherein the step of executing the population-based algorithm to tune and evaluate the policy group, in order to generate the one or more evaluation results comprises:
determining whether a configuration of the each of the one or more policies meets a constraint of the compiler; and
in response to the configuration of the each of the one or more policies not meeting the constraint of the compiler, revising the configuration of the each of the one or more policies according to the constraint of the compiler.

4. The neural network optimization method of claim 1, wherein the step of executing the learning-based algorithm to tune the one or more policies according to the one or more evaluation results, in order to generate the one or more tuned policies comprises:
transferring the one or more tuned policies to the policy group, in order to update the one or more policies comprised in the policy group.

5. The neural network optimization method of claim 4, wherein the step of executing the learning-based algorithm to tune the one or more policies according to the one or more evaluation results, in order to generate the one or more tuned policies comprises:
determining whether an index value reaches a predetermined value;
in response to the index value not reaching the predetermined value, keeping executing the population-based algorithm and the learning-based algorithm in order to update the one or more policies comprised in the policy group; and
in response to the index value reaching the predetermined value, starting to perform the inference operation according to the neural network and the one or more tuned policies, in order to generate the multiple configuration candidates.

6. The neural network optimization method of claim 1, wherein the step of performing the inference operation according to the neural network and the one or more tuned policies, in order to generate the multiple configuration candidates comprises:
determining whether each of the multiple configuration candidates meets a constraint of the compiler; and
in response to the each of the multiple configuration candidates not meeting the constraint of the compiler, revising the each of the multiple configuration candidates according to the constraint of the compiler.

7. The neural network optimization method of claim 1, wherein the target neural network is the neural network.

8. The neural network optimization method of claim 1, wherein the target neural network is another neural network different from the neural network.

9. A non-transitory machine-readable medium for storing a program code, wherein when loaded and executed by a processor, the program code instructs the processor to perform a neural network optimization method, and the neural network optimization method comprises:
executing a population-based algorithm to tune and evaluate a policy group, in order to generate one or more evaluation results, wherein the policy group comprises one or more policies, and each of the one or more policies is related to a neural network;
executing a learning-based algorithm to tune the one or more policies according to the one or more evaluation results, in order to generate one or more tuned policies;
performing an inference operation according to a target neural network and the one or more tuned policies, in order to generate multiple configuration candidates; and
performing a selection operation upon the multiple configuration candidates to generate an optimal configuration, for outputting to a compiler and generating an optimized neural network, wherein the optimized neural network is an optimized version of the target neural network.

10. The non-transitory machine-readable medium of claim 9, wherein the step of executing the population-based algorithm to tune and evaluate the policy group, in order to generate the one or more evaluation results comprises:
evaluating the each of the one or more policies according to at least one objective of the neural network, in order to determine whether to remain the each of the one or more policies in the policy group.

11. The non-transitory machine-readable medium of claim 9, wherein the step of executing the population-based algorithm to tune and evaluate the policy group, in order to generate the one or more evaluation results comprises:
determining whether the configuration of the each of the one or more policies meets a constraint of the compiler; and
in response to the configuration of the each of the one or more policies not meeting the constraint of the compiler, revising the configuration of the each of the one or more policies according to the constraint of the compiler.

12. The non-transitory machine-readable medium of claim 9, wherein the step of executing the learning-based algorithm to tune the one or more policies according to the one or more evaluation results, in order to generate the one or more tuned policies comprises:
transferring the one or more tuned policies to the policy group, in order to update the one or more policies comprised in the policy group.

13. The non-transitory machine-readable medium of claim 12, wherein the step of executing the learning-based algorithm to tune the one or more policies according to the one or more evaluation results, in order to generate the one or more tuned policies comprises:
determining whether an index value reaches a predetermined value;
in response to the index value not reaching the predetermined value, keeping executing the population-based algorithm and the learning-based algorithm in order to update the one or more policies comprised in the policy group; and
in response to the index value reaching the predetermined value, starting to perform the inference operation according to the neural network and the one or more tuned policies, in order to generate the multiple configuration candidates.

14. The non-transitory machine-readable medium of claim 9, wherein the step of performing the inference operation according to the neural network and the one or more tuned policies, in order to generate the multiple configuration candidates comprises:
determining whether each of the multiple configuration candidates meets a constraint of the compiler; and
in response to the each of the multiple configuration candidates not meeting the constraint of the compiler, revising the each of the multiple configuration candidates according to the constraint of the compiler.

15. The non-transitory machine-readable medium of claim 9, wherein the target neural network is the neural network.

16. The non-transitory machine-readable medium of claim 9, wherein the target neural network is another neural network different from the neural network.
